(19) United States
(12) Patent Application Publication
(10) Pub. No.: US 2015/0376028 A1
(43) Pub. Date: Dec. 31, 2015

(54) DEVICE AND METHOD FOR THE PURIFICATION OF BIOLOGICALLY CONTAMINATED WATER

(71) Applicant: Seldon Technologies, Inc., Windsor, VT (US)

(72) Inventors: Christopher H. Cooper, Santa Fe, NM (US); Daniel Iliescu, White River Junction, VT (US); Mikhail Starostin, Windsor, VT (US); Vardhan Bajpai, Ellington, CT (US); Beatrice Iliescu, White River Junction, VT (US)

(21) Appl. No.: 14/844,430

(22) Filed: Sep. 3, 2015

Related U.S. Application Data
(63) Continuation of application No. PCT/US2014/024990, filed on Mar. 12, 2014.
(60) Provisional application No. 61/780,313, filed on Mar. 13, 2013.

(51) Int. Cl. C02F 1/00

(52) U.S. Cl. CPC C02F 1/001; C02F 2101/00

(57) ABSTRACT

Disclosed herein are devices and methods for the purification of biologically contaminated water to make potable. In one embodiment, there is disclosed a low-pressure device comprising a housing having at least one inlet for receiving biologically contaminated water, and at least one outlet for removing purified water, wherein the housing contains a filter held in place by a seal sufficient to keep the biologically contaminated water separate from the purified water. Because of the novel permeability and purification properties of the disclosed carbon containing filter, the disclosed filter can remove virus, bacteria, cyst or any combination thereof, at water approaching velocity up to 5 cm/min. In various embodiments, the filter can have a flat planar design to be used in a flat pack application, or a more traditional tubular shape.

The present application is a continuation of International Application No. PCT/US2014/024990, filed on Mar. 12, 2014, which claims priority to U.S. Provisional Application No. 61/780,313, filed on Mar. 13, 2013. The entire contents of each of the aforementioned applications are incorporated herein by reference.

The present disclosure relates to a devices for purifying water. In particular, the present disclosure relates to devices and methods for removing biological contaminants from water by passing the contaminated water through at least one carbon containing material. The present disclosure also relates to various designs and morphologies of the devices used to purify water, including low-pressure flat-planar designs.

There are many procedures and processes to treat fluids for consumption, use, disposal, and other needs. Among the most prevalent are pasteurization to sterilize foodstuffs, chemical treatments to sterilize water, distillation to purify liquids, centrifugation and filtration to remove particulates, decanting to separate two phases of fluids, reverse osmosis to desalinate liquids, electrodialysis to desalinate liquids, and catalytic processes to covert undesirable reactants into useful products. Each of these methods is well-suited for particular applications so usually a combination of methods is used for a final product.

There are many different technologies available for the sterilization of liquid. Adsorption, chemical treatments, ozone disinfection, and UV irradiation all perform very well for the removal of pathogenic microbes. However, each of these technologies has limitations, including overall efficacy, initial & operating cost, byproduct risk, necessary pre-treatment of liquid, hazardous compounds used or produced, and other limitations.

Although chemical methods are the most widespread in use, they have a number of shortcomings. Such drawbacks include increasing microbiological adaptation to their destructive effects (e.g. Cryptosporidium parvum), safety hazards associated with chlorine use and storage, and environmental impact. UV is gaining in popularity but the liquid must be clear in order for it to be effective, it does not break down any biofilm formation, and it is very expensive to install and operate.

In industrial and municipal applications such as water and wastewater plants, the three most widely used methods of liquid sterilization are: ozone, chlorine, and ultraviolet irradiation. Recent publications of the U.S. Environmental Protection Agency have identified the pros and cons of each method.

Ozone is more effective than Chlorine at destroying viruses and bacteria, has a short contact time (10-30 minutes) for effectiveness, leaves no harmful residuals as it breaks down quickly, and is generated onsite so there are no transportation risks. On the other hand, at low dosages ozone may not be effective, it is more complex than either UV or chlorine, it is very reactive and corrosive, it is toxic, capital costs can be high and power requirements can be high.

Chlorine is more cost-effective than ozone or UV, its residual can prolong disinfection, it is reliable and effective against a range of pathogenic organisms, and it offers flexible dosing control. Chlorine, though, carries with it significant risks including the facts that chlorine residual is toxic to aquatic life, chlorine is corrosive and toxic, chlorine's oxidation of organic matter creates hazardous compounds, and some parasitic species have shown resistance. In addition, chlorine can bind with natural organic material to create carcinogenic compounds hazardous for consumption.

Ultraviolet irradiation has been used for some time because it effectively inactivates most spores, viruses, and cysts, eliminates risks of handling chemicals, leaves no residual that can be harmful, is user-friendly to operators, requires a very short contact time (20-30 seconds) for effectiveness and requires less space. The downsides of UV irradiation include: that at low dosages it may not be effective; that organisms can sometimes reverse and repair UV damage; that tubes can foul requiring frequent preventative maintenance; that turbidity can render UV ineffective, the energy requirements are very high. Further, disposal of hazardous UV lamps can be expensive.

In response to the shortcomings of known disinfection methods, a number of new approaches have been tried. For example, U.S. Pat. No. 6,514,413, which is herein incorporated by reference, discloses using a composite, bactericidal adsorption material. Such bactericidal adsorption material, however, have been shown to be prone to biofouling and bacterial grow-through for continued reproduction. U.S. patent application Ser. No. 09/907,092 discloses a portable oxidant generator for generating a chlorine or chlor-oxygen solution for sterilizing contaminated drinking water. U.S. Pat. No. 6,495,052 discloses a system and method for treatment of water that introduces a bactericide into the water and then removes it prior to consumption. U.S. patent application Ser. No. 10/029,444 discloses a method whereby water is subjected to light from a laser as means of disinfection. The foregoing patents and applications are herein incorporated by reference in their entireties.

Again, however, these approaches rely on high inputs of electricity, toxic chemicals, or long contact times for effectiveness. What is still needed is a method that has minimal energy requirements, utilizes no toxic chemicals, and requires a very short contact time, and can be embodied into a portable device.

### SUMMARY OF THE INVENTION

There is disclosed a device for the purification of biologically contaminated water to make potable water. In one embodiment, the device comprises a housing having at least one inlet for receiving biologically contaminated water, and at least one outlet for removing purified water.

The housing disclosed herein contains a filter held in place by a seal sufficient to keep the biologically contaminated water separate from the purified water, such as with an epoxy that is compliant with National Sanitation Foundation standards.

In one embodiment, the filter used in the disclosed devices comprises at least one carbon containing layer having a water permeability ranging from 0.05 Darcies to 20 Darcies. In addition, the filter is one that is able to remove biological contaminates chosen from virus, bacteria, cyst or any combination thereof, at water approaching velocity up to 5 cm/min. In one embodiment, the disclosed filter is sufficient to reduce the biological concentration of viruses by at least 10,000 times (4 LRV), reduce concentration of bacteria by at least one million times (6 LRV), and reduce concentration of cysts by one thousand times (3 LRV).

Non-limiting examples of the types of contaminants that can be removed using the disclosed device include virus, bacteria, parasites, endotoxins, pesticides, organophosphates, hormone analogs, pharmaceuticals, and microorganisms

The carbon containing layer comprises at least one carbonaceous material, such as but not limited to carbon nanotubes, carbon particulates, activated carbon, graphene, carbon-nanohorns, carbon-nanospirals, carbon-nanowebbing, or any combination thereof. The carbon nanotubes used in the disclosed carbon containing layer may comprise a certain amount of surface grown carbon nanotubes, such as at least 0.01% by weight of the carbon containing layer comprises.

In one embodiment, the at least one carbon containing layer comprises a nanomesh of carbon nanotubes and fibrous materials, such as fibers made of glass ceramic, carbon, metals, polymers, or combinations thereof. In another embodiment, the nanomesh further comprises an activated carbon material.

In one embodiment, the device may comprise at least one pre-filter to produce a pre-filtered water that is subsequently introduced into the filter to produce a purified water. This pre-filter may be contained in the same housing, or in a separate housing attached to the device. Whether located in the same or in a separate housing, the pre-filter may comprise at least one of the previously described carbon containing layers, such as two or more. Likewise, the filter may comprise at least one of the carbon containing layers, but typically it comprises at least two of such layers.

In one embodiment, the device can be made into a variety of shapes. For example, the housing and filter may have a geometric form chosen from tubular, flat-planar, pleated, fractal, or any combination thereof. When in a tubular-shaped, the pre-filter and filter may have a concentric structure, such as with the pre-filter located on the inside of the concentric structure. In this embodiment, the contaminated water comes into the center of the device, and the clean water flows out to the sides. Alternatively, the pre-filter may be located on the outside of the concentric structure. In this embodiment, the contaminated water comes into the filter from the outside, and the clean water flows down the center of the device.

Regardless of the shape, the pre-filter and filter typically comprises at least one carbon containing layer, such as at least two, or any number of layers (n) necessary to remove the previously described contaminants to achieve a biological concentration of viruses by at least 10,000 times (4 LRV), reduce concentration of bacteria by at least one million times (6 LRV), and reduce concentration of cysts by one thousand times (3 LRV). In various embodiments, the at least 0.1% by weight of the carbon containing layer of the pre-filter, the filter, or both comprise surface grown carbon nanotubes. In addition, the carbon containing layer of the pre-filter, the filter, or both may also contain an activated carbon material.

Finally, there is disclosed a method of purifying biologically contaminated water which comprises passing biologically contaminated water through a filter as previously described. In one embodiment, the method may optionally comprise passing the contaminated water through a pre-filter comprising at least one carbon containing layer to produce a pre-filtered water, and the passing the pre-filtered water through the filter to produce a potable water product.

The foregoing and other features of the present disclosure will be more readily apparent from the following detailed description of exemplary embodiments, taken in conjunction with the attached drawings. It will be noted that for convenience all illustrations of devices show the height dimension exaggerated in relation to the width.

### BRIEF DESCRIPTION OF THE DRAWINGS

FIG. 1 shows a schematic of a flat-planar device made according to the present invention.

Elements

| Element No. | Description |
|---|---|
| 114 | cover plate |
| 104 | Clean side Media frame |
| 110 | Main-Filtration Media |
| 108 | Pre-Filtration Media |
| 106 | Dirty side Media frame |
| 104, 110, 108, 106 | Media-pack subassembly |
| 112 | Epoxy |
| 102 | Separator for two media-packs and water channel |
| | manifold comprising 1 inlet, 1 outlet, 1 air vent, |
| | 1 clean side water channel |

FIG. 2 shows a schematic cross section side view of media-pack assembly (see FIG. 1) in the present invention.

Elements

| Element No. | Description |
|---|---|
| 104 | Clean side Media frame |
| 106 | Dirty side Media frame |
| 110 | Main-Filtration Media |
| 108 | Pre-Filtration Media |
| 112 | epoxy |

FIG. 3 is a cross-sectional view of the flat purification device of FIG. 1. This device is made according to the present invention in which contaminated water enters through the center of the device. The water is then pushed through the media packs on each side of the separator as shown. At least one carbon layer thereby removes the said contaminants. The housing is constructed such that the clean water is not in contact with the dirty water.

FIG. 4 is TGA experiment to illustrate the attachment of C-18 chains onto carbon nanotube surface.

FIG. 5 shows water contact angles with the CNANO carbon nanotube films [A] CNT-HCL functionalization; [B] Raw CNT: mechano-chemical functionalization; [C] CNT-stearic acid functionalization.

FIG. 6 shows flow rate as a function of pressure for purification media samples for the present invention. The data was taking using a PMI instrument disclosed herein. This figure is related to example 5.

FIG. 7 shows flow rate as a function of pressure for purification media samples for the present invention. The data was taking using a PMI instrument disclosed herein. This figure is related to example 5.

### DETAILED DESCRIPTION OF THE INVENTION

### Definitions

The following terms or phrases used in the present disclosure have the meanings outlined below;

The term “nanotube” refers to a tubular-shaped, molecular structure generally having an average diameter in the inclusive range of 1-60 nm and an average length in the inclusive range of 0.1 urn to 250 mm.

The term “carbon nanotube” or any version thereof refers to a tubular-shaped, molecular structure composed primarily of carbon atoms arranged in a hexagonal lattice (a graphene sheet) which closes upon itself to form the walls of a seamless cylindrical tube. These tubular sheets can either occur alone (single-walled) or as many nested layers (multi-walled) to form the cylindrical structure.

The term “functional group” is defined as any atom or chemical group that provides a specific behavior. The term “functionalized” is defined as adding a functional group(s) to the surface of the nanotubes and/or the additional fiber that may alter the properties of the nanotube, such as zeta potential. A description of various functional groups that can be used in the present disclosure, and methods of functionalizing carbon nanotubes is found in Applicants' prior U.S. Pat. No. 7,815,806, which is herein incorporated by reference in its entirety.

The terms “fused,” “fusion,” or any version of the word “fuse” is defined as the bonding of nanotubes, fibers, or combinations thereof, at their point or points of contact. For example, such bonding can be Carbon-Carbon chemical bonding including sp³ hybridization or chemical bonding of carbon to other atoms. A description of a fused nanomaterial that can be used in the present disclosure is found in Applicants' prior U.S. Pat. No. 7,682,654, which is herein incorporated by reference in its entirety.

The terms “interlink,” “interlinked,” or any version of the word “link” is defined as the connecting of nanotubes and/or other fibers into a larger structure through mechanical, electrical or chemical forces. For example, such connecting can be due to the creation of a large, intertwined, knot-like structure that resists separation.

The terms “nanostructured” and “nano-scaled” refers to a structure or a material which possesses components having at least one dimension that is 100 nm or smaller. A definition for nanostructure is provided in The Physics and Chemistry of Materials, Joel I. Gersten and Frederick W. Smith, Wiley publishers, p 382-383, which is herein incorporated by reference for this definition.

The phrase “nanostructured material” refers to a material whose components have an arrangement that has at least one characteristic length scale that is 100 nanometers or less. The phrase “characteristic length scale” refers to a measure of the size of a pattern within the arrangement, such as but not limited to the characteristic diameter of the pores created within the structure, the interstitial distance between fibers or the distance between subsequent fiber crossings. This measurement may also be done through the methods of applied mathematics such as principle component or spectral analysis that give multi-scale information characterizing the length scales within the material.

The term “permeability” as used herein refers to the conductance of a fluid through a porous material. In other words it is the flow rate of a fluid through a porous structure as a function of thickness of structure and pressure.

The term “nanomesh” refers to a nanostructured material defined above, and that further is porous. For example, in one embodiment, a nanomesh material is generally used as a filter media, and thus must be porous or permeable to the fluid it is intended to purify. A description of a nanomesh that can be used in the present disclosure is found in Applicants' prior U.S. Pat. No. 7,419,601, which is herein incorporated by reference in its entirety.

The terms “large” or “macro” alone or in combination with “scale” refers to materials that comprise a nanostructured material, as defined above, that have been fabricated using the methods described herein to have at least two dimensions greater than 1 cm. Non-limiting examples of such macro-scale, nanostructured material is a sheet of nanostructured material that is 1 meter square or a roll of nanostructured material continuously fabricated to a length of at least 100 meters. Depending on the use, large or macro-scale is intended to mean larger than 10 cm, or 100 cm or even 1 meters, such as when used to define the size of material made via a batch process. When used to describe continuous or semi-continuous methods, large scale manufacturing can encompass the production of material having a length greater than a meter, such as greater than one meter and up to ten thousand meters long.

The phrase “active material” is defined as a material that is responsible for a particular activity, such as removing contaminants from the fluid, whether by physical, chemical, bio-chemical or catalytic means. Conversely, a “passive” material is defined as an inert type of material, such as one that does not exhibit chemical properties that contribute to the removal contaminants when used as a filter media.

The phrase, “high surface area carbon” is intended to mean a carbon (including any allotrope thereof) having a surface area greater than 500 m²/g as determined by adsorption isotherms of carbon dioxide gas at room or 0.0° C. temperature. In one embodiment, the surface area of the high surface area carbon is greater than 1000 m²/g or up to and including 2500 m²/g. In one embodiment, the high surface area carbon may be any number between the range of 500 m²/g and 2500 m²/g, including increments of 50 m²/g from 500 m²/g and 2500 m²/g. In one embodiment, the high surface area carbon may be an activated carbon, wherein the level of activation sufficient to be useful in the present application may be attained solely from high the surface area; however, further chemical treatment may be performed to enhance the useful properties, such as adsorption properties.

The term “fiber” or any version thereof, is defined as an object of length L and diameter D such that L is greater than D, wherein D is the diameter of the circle in which the cross section of the fiber is inscribed. In one embodiment, the aspect ratio L/D (or shape factor) of the fibers used may range from 2:1 to 100:1. Fibers used in the present disclosure may include materials comprised of one or many different compositions.

The term “particulate” or any version thereof, is defined as an object whose dimensions are roughly of the same order of magnitude in all directions.

The prefix “nano-” (as in “carbon nanotubes”) refers to objects which possess at least one dimension on the order of one billionth of a meter, 10⁻⁹ meters, to 100 billionths of a meter, 10⁻⁷ meters. Carbon nanotubes described herein generally have an average diameter in the inclusive range of from about 1-60 nm and an average length in the inclusive range from 0.1 mm to 250 mm, typically from 1 mm to 10 mm.

A “processed substrate” refers to a graphite sheet whose surface was first cleaned, for example with detergent; then rinsed, for example with water; dried; then rinsed again, for example with ethanol; and roughened, for example using 60-grit sandpaper to create asperities onto which the ultra-long carbon nanotubes attach.

The term “fluid” is intended to encompass liquids or gases.

The phrase “loaded carrier fluid,” refers to a carrier fluid that further comprises at least carbon nanotubes, and the optional components described herein, such as glass fibers.

The term “contaminant(s)” means at least one unwanted or undesired element, molecule or organism in the fluid. In one embodiment, contaminants include

salts in water. A description of a various contaminants and methods of removing them using nanomesh is found in Applicants' prior U.S. Pat. No. 7,211,320, which is herein incorporated by reference in its entirety.

The term “removing” (or any version thereof) means destroying, modifying, or separating contaminants using at least one of the following mechanisms: particle size exclusion, absorption, adsorption, chemical or biological interaction or reaction.

The phrase “chemical or biological interaction or reaction” is understood to mean an interaction with the contaminant through either chemical or biological processes that renders the contaminant incapable of causing harm. Examples of this are reduction, oxidation, chemical denaturing, physical damage to microorganisms, bio-molecules, ingestion, and encasement.

The term “particle size” is defined by a number distribution, e.g., by the number of particles having a particular size. The method is typically measured by microscopic techniques, such as by a calibrated optical microscope, by calibrated polystyrene beads, by calibrated scanning probe microscope scanning electron microscope, or optical near field microscope. Methods of measuring particles of the sizes described herein are taught in Walter C. McCrone's et al., The Particle Atlas, (An encyclopedia of techniques for small particle identification), Vol. I, Principles and Techniques, Ed. 2 (Ann Arbor Science Pub.), which are herein incorporated by reference.

The phrases “chosen from” or “selected from” as used herein refers to selection of individual components or the combination of two (or more) components. For example, the nanostructured material can comprise carbon nanotubes that are only one of impregnated, functionalized, doped, charged, coated, and defective carbon nanotubes, or a mixture of any or all of these types of nanotubes such as a mixture of different treatments applied to the nanotubes.

The functionalized ultra-long carbon nanotubes are typically longer than 0.5 mm, such as from 0.1 mm to 250 mm. In addition, the other allotropes of carbon typically have an active surface area greater than 1000 m²/g, such as from 1000 to 2500 m²/g. The phrase “surface grown carbon nanotubes” as used herein refers to carbon nanotubes that have been synthesized as a substantially aligned forests of carbon nanotubes on a substrate. Subsequently this forest has been delaminated from the synthesis substrate and dispersed into the filtration media.

In one embodiment, the ultra-long carbon nanotube material may be in the geometrical form of a thread, a cable, a woven fabric, a non-woven material, a 3D printed part, a 3D woven form or any combination thereof.

In one embodiment, the functionalized ultra-long carbon nanotubes are longer than about 0.5 mm, such as from about 0.1 mm to about 250 mm, typically between about 1 mm and about 10 mm.

In one embodiment, the permeability ranges from about 0.05 Darcy to about 20 Darcies.

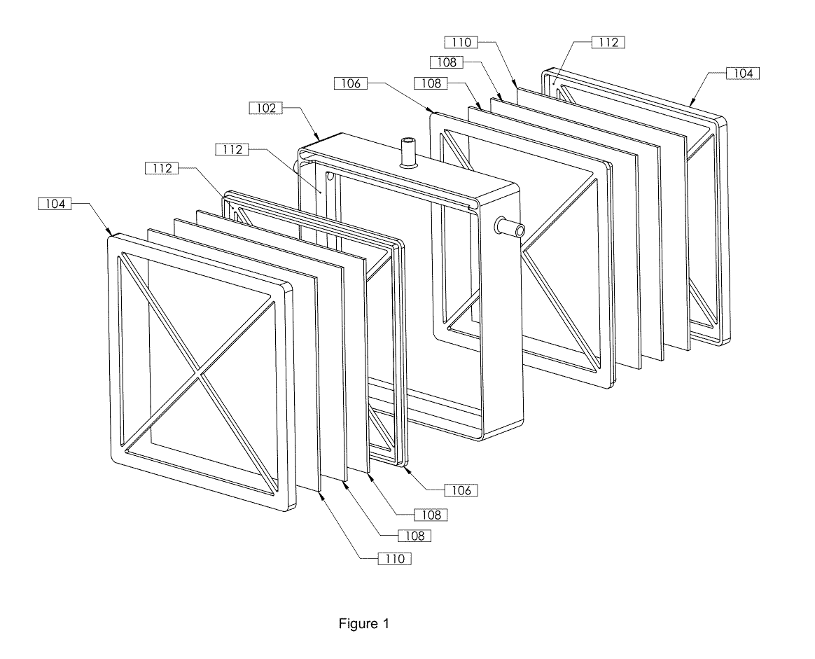

With reference to FIG. 1, there is shown a schematic of a flat-planar device made according to the present invention. In particular, FIG. 1 shows Cover Plates 114, on the outside of the Clean Side Media Frames 104, that hold the Main-Filtration Media 110, as well as the Pre-Filtration Media 108. FIG. 1 also shows the dirty Side Media Frame 106. The entire Media-pack Subassembly 104,110,108,106, shows where the Epoxy 112, is located in Separator 102. This Figure particularly shows an embodiment for two media-packs and water channel manifold comprising one inlet, one outlet, one air vent, and one clean side water channel.

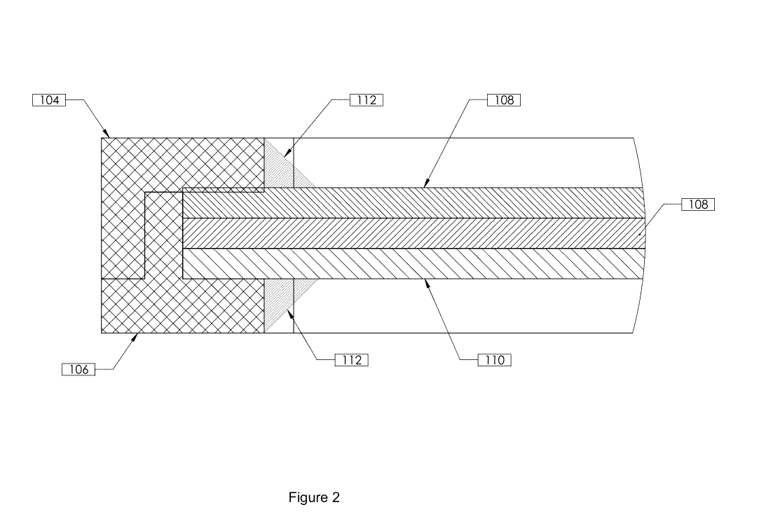

FIG. 2 shows a schematic cross section side view of media-pack assembly of FIG. 1. In particular, FIG. 2 is focused on the Clean Side Media Frames 104, that hold the Main-Filtration Media 110, as well as the Pre-Filtration Media 108. Like FIG. 1, FIG. 2 also shows the dirty Side Media Frame 106 and Epoxy 112, which would be on the Separator 102 (not shown).

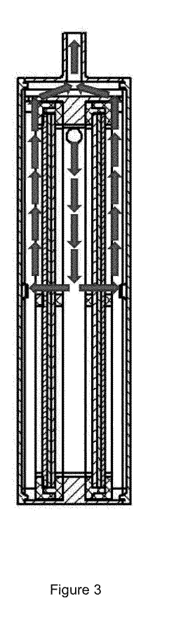

FIG. 3 is a cross-sectional view of the flat purification device of FIG. 1. This device is made according to the present invention in which contaminated water enters through the center of the device. The water is then pushed through the media packs on each side of the separator as shown. At least one carbon layer thereby removes the contaminants. The housing is constructed such that the clean water is not in contact with the dirty water.

An example of how flow rate was measured is provided in U.S. Pat. No. 8,038,013, which is herein incorporated by reference in its entirety. This patent particularly teaches that the Specific Water Flow Rate (also referred to as Flux) is the volumetric flow rate at which fluid passes through the sample of a given area, as measured by passing deionized water through filter medium samples having a diameter of 2.217 cm. The water was forced through the samples using hydraulic pressure (water head pressure) or pneumatic pressure (air pressure over water). The test uses a fluid filled column containing a magnetic float, and a sensor attached to the column reads the position of the magnetic float and provides digital information to a computer. Flow rate is calculated using data analysis software supplied by PMI.”

In particular, the flow of liquid through a sample can be measured using a technique developed by the company Porous Materials Inc (PMI)™. In this method, the flow of liquid through a sample is measured by the distance a column of liquid drops in relation to time and pressure. This method gives reproducible results, even for hydrophobic materials, as pressure can be applied up to 200 psi to the liquid column to force the liquid through the sample. Very low permeability samples are tested using an accurate weighing balance to measure liquid flow rate.

The present disclosure is further illustrated by the following non-limiting examples, which are intended to be purely exemplary of the disclosure.

### Examples

### Example 1

### Manufacture of Inventive Flat-Planar Device

The example describes devices made in accordance with an inventive flat-planar design. Reference is made to FIG. 1, in this example. First, two elements of pre-filtration media 108 and one main filtration media 110 were cut to the appropriate dimensions. The edges of these media 108 and 110 were then sealed by applying a mixture of paraffin wax and hot melt. For proper sealing, it was insured that the adhesive penetrated at least 1 mm into each edge, and typically penetrated about 1 mm to 5 mm into each edge.

Next, the surfaces of frames and separator elements 102, 104 and 106 were prepared for adhesion, which consisted of lightly abrading the surfaces with sandpaper. Once the sanding was completed, fine particles were removed from the surface, which was wiped down with isopropyl alcohol.

A 2-5 mm thick bead of epoxy 112 was then applied around the inside edge of 106, followed by the application of one piece of pre-filtration media 108 into element frame 106. A 2-5 mm thick bead of epoxy 112 was again applied along the same inside of edge of 106 as before, but now on top of pre-filtration media 108. The previous two steps were repeated for adding the second layer of filtration media. Lay down one piece of main filtration media 110.

Another 2-5 mm thick bead of epoxy 112 was applied on top of main filtration media 110 along the inside edge of 106. One more 2-5 mm thick bead of epoxy 112 was placed along the inside edge of frame 104. After the various layers were in places, frame 104 was put onto frame 106, thereby enclosing pre filtration and main filtration media elements 108, 110 and 112.

Next the entire assembly was clamped down from above the assembly until element 112 has cured enough to remain in the clamped position with no external forces. The foregoing steps were repeated to form a second filter pack.

Next, the surfaces of element 102 were again prepared for adhesion, which consisted of lightly abrading the surfaces with sandpaper. Once the sanding was completed, fine particles were removed from the surface, which was wiped down with isopropyl alcohol.

A 2-5 mm thick bead of epoxy 112 was then applied along the inside edge of element 102, and the filter pack was inserted into separator element 102 so that the bottom surface of frame 106 sat on one side of separator element 102. These same steps were repeated on the opposite side of separator element 102.

Finally, elements 114 were placed on each side of 102 to enclose both filter packs, and epoxy 112 was used to seal element 114 to separator element 102. The finished assembly was cured in ambient conditions prior to being used.

### Example 2

### Performance Evaluation of Flat-Planar Device of Example 1

After curing, a flat-planar device prepared according to Example 1 was tested for MS2, which is commonly used as a surrogate in assessing treatment capabilities of membranes designed for treating drinking water, is a single stranded RNA virus, with a diameter of 0.025 urn and an icosahedron shape. Its size and shape are similar to other water related viruses such as the poliovirus and hepatitis.

In addition, another flat-planar device prepared according to Example 1 was tested for the bacteria raoultella terrigena (“RT”). Raoultella terrigena (previously known as Klebsiella terrigena) is a gram-negative bacterium and mainly reported as aquatic and soil organism. RT has phylogenic comparisons to the 16s rRNA and rpoB genes of this and other Klebsiella species, and thus provides similar removal properties of a variety of this and other bacteria.

Results of the foregoing testing is shown in Table 1, with the challenge level and removal levels for each sample tested from 50 L to 892 L. As shown, the specific challenge level of each contaminated sample tested, and the removal efficiencies As shown, the inventive device shows essentially complete removal of both MS2 and RT contaminants across the entire tests, i.e., 50-892 liters.

TABLE 1

| | | |
|---|---|---|
| Volume at | MS2 Performance | RT Performance |

| Spike (L) | Removal | Challenge | Removal | Challenge |
|---|---|---|---|---|
| 50.0 | 6.4 | 6.4 | 7.7 | 7.7 |
| 119.5 | 6.7 | 6.7 | 8.2 | 8.2 |
| 252.3 | 6.5 | 6.5 | 8.1 | 8.1 |
| 413.7 | 6.4 | 6.4 | 8.2 | 8.2 |
| 453.5 | 6.5 | 6.5 | 8.1 | 8.1 |
| 504.9 | 6.5 | 6.5 | 8.3 | 8.3 |
| 544.1 | 6.3 | 6.3 | 8.5 | 8.5 |
| 651.2 | 6.1 | 6.1 | 8.4 | 8.4 |
| 747.6 | 6.4 | 6.4 | 8.4 | 8.4 |
| 816.7 | 6.5 | 6.5 | 8.0 | 8.0 |
| 841.7 | 6.5 | 6.5 | 8.5 | 8.5 |
| 866.7 | 6.3 | 6.3 | 8.4 | 8.4 |
| 881.7 | 6.4 | 6.4 | 8.3 | 8.3 |
| 892.0 | 6.4 | 6.4 | 8.4 | 8.4 |

### Example 3

### Testing of Removal Efficacy of Insoluble Organics

This example shows the inventive filters efficacy of removing insoluble organic contaminants from water. In particular, it was demonstrated that bis-2-ethylhexyl phathalate which has a very large molecular weight (390.6 g) and ibuprofen, could be removed to the detection limits of the devices used in this study, i.e., ppb levels.

In order to evaluate the removal capability of the inventive devices for bis-2-ethylhexyl phathalate two preliminary tests were performed. The first one involved testing with ethyl morpholine (the lowest molecular weight substance in the class) with the results being estimated by TOC analysis. The second test was performed with bis-2-ethylhexyl phathalate. For both tests, large filters of similar configuration (4 NanoMesh layers of different densities wrapped around either a plastic or carbon central core) were used.

The TOC analysis revealed somewhat elevated levels above the challenge for filtrate samples taken for the plastic core filter. However, the carbon core filters showed at least a 78% reduction in the TOC levels from the challenge level at all three sample points (1, 5 and 10 liters). The testing results for bis-2-ethylhexyl phathalate, presented in Table 2, show that all filtrate points reduced the concentration over 75% to below the detection level of 0.005 mg/L. Not surprisingly, this large molecular weight organic compound was most easily removed by the NanoMesh with both the carbon and plastic core filters equally effective at its removal.

TABLE 2
Removal results for bis-2-ethylhexyl phathalate.
All values are in mg/liter.

| | Carbon core | | Plastic Core | |
|---|---|---|---|---|
| Filter | 1 | 2 | 3 | 4 |
| Blank water (Seldon water) | 0.008 | 0.008 | 0.008 | 0.008 |
| Challenge Level | 0.022 | 0.022 | 0.022 | 0.022 |
| Sample @ 1 L challenge | <0.005 | <0.005 | <0.005 | <0.005 |
| Sample @ 15 L challenge | <0.005 | <0.005 | <0.005 | <0.005 |
| Sample @ 30 L challenge | <0.005 | <0.005 | <0.005 | <0.005 |

The filters used in this example were configured with 3 NanoMesh layers plus an additional outer layer of material which served as a bacterial barrier. Each filter was challenged with 30 L of a mixture of five insoluble organic compounds and analyzed for only ibuprofen. As shown in Table 3, the carbon core purifier outperformed the plastic core one for ibuprofen removal. In this case, the carbon core filter reduced the concentration in all the filtrate samples to below the detection levels (<590 mg/L) while the plastic core purifier removed only about 10%.

TABLE 3
Test results for ibuprofen. All values are in mg/L.

| | Carbon core | Plastic Core |
|---|---|---|
| Filter | #4034 | #4031 |
| Blank water (Seldon water) | <590 | <590 |
| Ersatz challenge | 860 | 950 |
| Sample @ 3 L challenge | <590 | 840 |
| Sample @ 30 L challenge | <590 | 820 |

### Example 4

### Chemistry of Carbon Nanotube to Attain Hydrophobic Surfaces

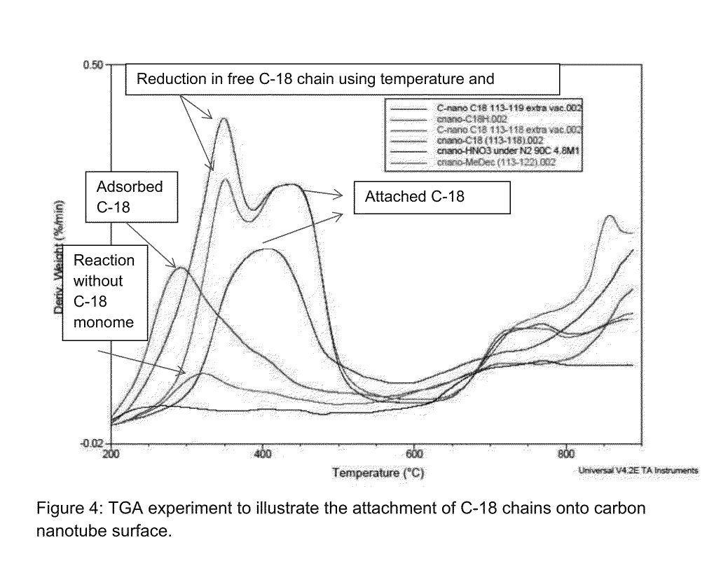

The goal of the chemistry experiments described in FIG. 4 was to understand the chemistry of carbon nanotube and use it to attain super hydrophobic surfaces within the media. As a result, the inventors functionalized the carbon nanotube through various techniques and assessed hydrophobic properties. One way to measure such properties was to measure the water contact angles on the films of functionalized carbon nanotube by using a tool that was specifically fabricated in-house to measure contact angle. The water-carbon nanotube contact angles were then measure.

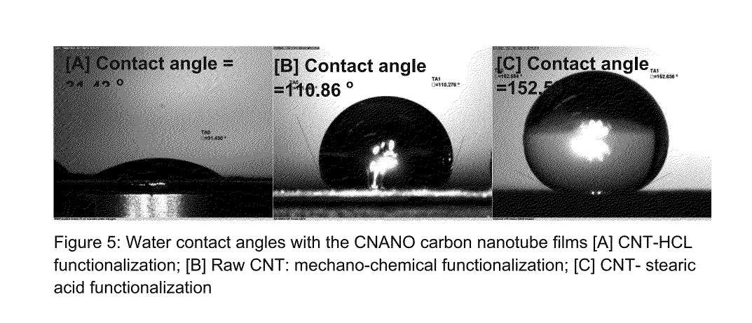

FIG. 5 presents the water contact angles on some of the functionalized carbon nanotube films. The carbon nanotube samples with C-18 attached chains achieved the highest contact angles of 152.39 degrees. However, contact angle of 110-135 degrees were achieved by other mechano-chemical functionalization techniques (microfluidics). Acid treatment was found to reduce the contact angle drastically and hence cannot be used for functionalization of carbon nanotube. However, acid treatments are needed to achieve dispersions in the media. Hence, additional reactions, such as C-18 chain addition, are needed to enhance the contact angle of carbon nanotube. Through this functionalization, the inventors discovered that they could modulate the hydrophobicity of the electrode materials to maximize the properties as required by the application environment.

### Example 5

### Water Permeability Measurements for Some Seldon Filtration Materials Technique

PMI CFP-1200AEXL Capillary Flow Porometer/Perm-Porometer s/n 11262012-3008 was used for the measurements. Samples Ø 47 mm were cut from the hand-sheet of corresponding material and placed into liquid permeability chamber. Pressure loading was 0-8 psi. Data for each type of tested material are shown below.

Sample 1, Nanomesh SP11728512C (Material Used in in-Lab WaterBox Tests)

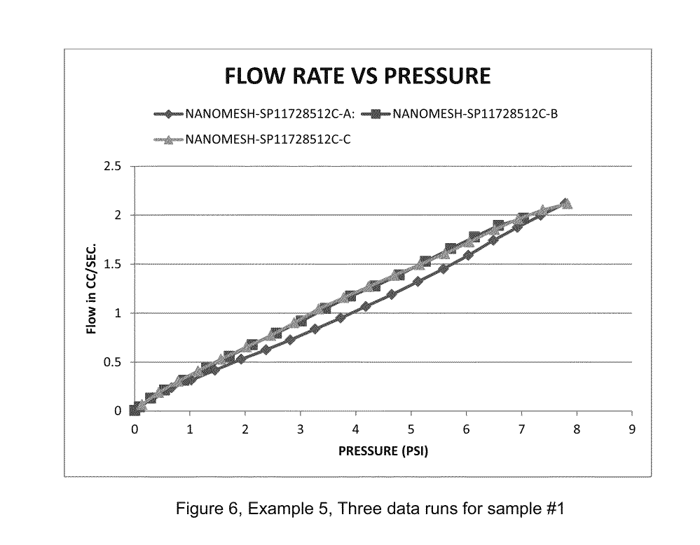

FIG. 6 shows three measurements (A,B,C) were taken for sample 1. Water Permeability data for sample #1 were 0.194 Darcies, 0.227 Darcies and 0.22 Darcies for measurements A, B, and C, correspondingly. Water Permeability data for sample #2 were 0.197 Darcies, 0.2557 Darcies and 0.238 Darcies for measurements A, B, and C, correspondingly. Water Permeability data for sample #3 were 0.257 Darcies, 0.325 Darcies and 0.311 Darcies for measurements A, B, and C, correspondingly. All A measurements (first after blank run for air bubbles removal) are noticeably lower; data for B and C are closed and probably better reflect actual permeability of the material. Average Water Permeability for all B and C samples is 0.26 Darcies. This material was made with a polyester bi-component fibers.

### Sample 2 Nanomesh SR13904913.

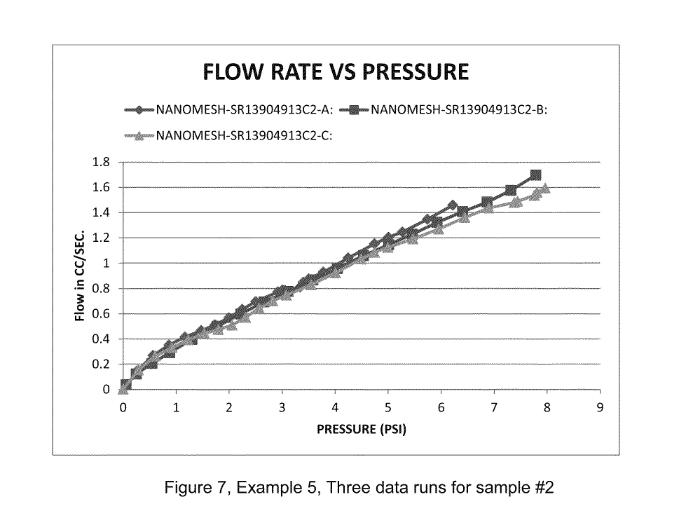

FIG. 7 shows three measurements (A,B,C) were taken for sample 2. Water Permeability data for sample #1 were 0.172 Darcies and 0.194 Darcies for measurements C and D measurements, correspondingly. Water Permeability data for sample #2 were 0.200 Darcies, 0.184 Darcies and 0.219 Darcies for measurements A, B, and C, correspondingly.

Water Permeability data for sample #3 were 0.181 Darcies and 0.198 Darcies for measurements A and B, correspondingly. So, average Water Permeability for this material is 0.191 Darcies. This material was made with a polypropylene bi-component fibers.

As used herein, the terms “a”, “an”, and “the” are intended to encompass the plural as well as the singular. In other words, for ease of reference only, the terms “a” or “an” or “the” may be used herein, such as “a layer”, “an assembly”, “the filter”, etc., but are intended, unless explicitly indicated to the contrary, to mean “at least one,” such as “at least one layer”, “at least one assembly”, “the at least one filter”, etc. This is true even if the term “at least one” is used in one instance, and “a” or “an” or “the” is used in another instance, e.g. in the same paragraph or section. Furthermore, as used herein, the phrase “at least one” means one or more, and thus includes individual components as well as mixtures/combinations.

The term “comprising” (and its grammatical variations) as used herein is used in the inclusive sense of “having” or “including,” with which it may be used interchangeably. These terms are not to be construed as being used in the exclusive sense of “consisting only of” unless explicitly so stated.

Other than where expressly indicated, all numbers expressing quantities of ingredients and/or reaction conditions are to be understood as being modified in all instances by the term “about.” This includes terms such as “all” or “none” and variants thereof. As used herein, the modifier “about” means within the limits that one of skill in the art would expect with regard to the particular quantity defined; this may be, for example, in various embodiments, +10% of the indicated number, ±5% of the indicated number, ±2% of the indicated number, ±1% of the indicated number, ±0.5% of the indicated number, or ±0.1% of the indicated number.

Additionally, where ranges are given, it is understood that the endpoints of the range define additional embodiments, and that sub-ranges including those not expressly recited are also intended to include additional embodiments.

As used herein, “formed from,” “generated by,” and variations thereof, mean obtained from chemical reaction of, wherein “chemical reaction,” includes spontaneous chemical reactions and induced chemical reactions. As used herein, the phrases “formed from” and “generated by” are open ended and do not limit the components of the composition to those listed.

The compositions and methods according to the present disclosure can comprise, consist of, or consist essentially of the elements and limitations described herein, as well as any additional or optional ingredients, components, or limitations described herein or otherwise known in the art.

It should be understood that, unless explicitly stated otherwise, the steps of various methods described herein may be performed in any order, and not all steps must be performed, yet the methods are still intended to be within the scope of the disclosure.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

What is claimed is:

1. A device for the purification of biologically contaminated water to make potable, said device comprising:
a housing comprising at least one inlet for receiving biologically contaminated water, and at least one outlet for removing purified water, wherein said housing contains a filter held in place by a seal sufficient to keep said biologically contaminated water separate from said purified water,
wherein said filter comprises at least one carbon containing layer sufficient to remove biological contaminates chosen from virus, bacteria, cyst or any combination thereof, said filter having a water permeability ranging from 0.05 Darcies to 20 Darcies at flow velocities over 1 cm/min and a pressure differential across the filter of less than 20 psi.

2. The device of claim 1, wherein said filter is sufficient to reduce the biological concentration of at least one of the following:
viruses by at least 10,000 times (4 LRV);
bacteria by at least one million times (6 LRV); and
cysts by one thousand times (3 LRV).

3. The device of claim 1, wherein said at least one carbon containing layer comprises carbon nanotubes, colossal carbon tubes, carbon particulates, activated carbon, graphene, carbon-nanohorns, carbon-nanospirals, carbon-nanowebbing, or any combination thereof.

4. The device of claim 1, wherein at least 0.01% by weight of the carbon containing layer comprises surface grown carbon nanotubes.

5. The device of claim 1, wherein said at least one carbon containing layer comprises a nanomesh of carbon nanotubes and fibrous materials.

6. The device of claim 5, wherein said nanomesh further comprises an activated carbon material.

7. The device of claim 5, wherein said fibrous material comprises ceramic, carbon, glass, metallic, polymeric, and combinations thereof.

8. The device of claim 1, further comprising at least one pre-filter contained in the same housing, or in a separate housing attached to said device.

9. The device of claim 1, wherein said pre-filter comprises at least one of said carbon containing layers and said filter comprises at least two said carbon containing layers.

10. The device of claim 1, wherein said housing and filter has a geometric form chosen from tubular, flat-planar, pleated, fractal, or any combination thereof.

11. The device of claim 1, wherein said filter further comprises a non-carbon fibrous material.

12. A tubular-shaped assembly for the purification of biologically contaminated water, said assembly comprising:
a pre-filter comprising at least one carbon containing layer; and
a filter located adjacent the pre-filter, and comprising at least one carbon containing layer, wherein the at least one carbon containing layer of the pre-filter, the filter, or both the pre-filter and the filter has a water permeability ranging from 0.05 Darcies to 20 Darcies, and is able to remove biological contaminates chosen from virus,
bacteria, cyst or any combination thereof, at a flow velocity over 5 cm/min, wherein said filter optionally comprises a non-carbon fibrous material.

13. The tubular-shaped assembly of claim 12, wherein said pre-filter and filter are in a concentric structure.

14. The tubular-shaped assembly of claim 13, wherein said pre-filter is located on the inside of said concentric structure.

15. The tubular-shaped assembly of claim 13, wherein said pre-filter is located on the outside of said concentric structure.

16. The tubular-shaped assembly of claim 12, wherein said pre-filter comprises at least three of said carbon containing layers and said filter comprises at least two said carbon containing layers.

17. The tubular-shaped assembly of claim 12, wherein the combination of said pre-filter and said filter reduce the biological concentration of at least one of the following:
viruses by at least 10,000 times (4 LRV);
bacteria by at least one million times (6 LRV); and
cysts by one thousand times (3 LRV).

18. The tubular-shaped assembly of claim 12, wherein at least 0.1% by weight of the carbon containing layer of the pre-filter, the filter, or both are surface grown carbon nanotubes.

19. The tubular-shaped assembly of claim 12, wherein the carbon containing layer of the pre-filter, the filter, or both further contain an activated carbon material.

20. A flat-planar assembly for the purification of biologically contaminated water, said assembly comprising:
a pre-filter comprising at least one carbon containing layer; and
a filter located adjacent the pre-filter, and comprising at least one carbon containing layer, wherein the at least one carbon containing layer of the pre-filter, the filter, or both the pre-filter and the filter has a water permeability ranging from 0.05 Darcies to 20 Darcies, and is able to remove biological contaminates chosen from virus, bacteria, cyst or any combination thereof, at a flow of at least 1 cm/min,
wherein said filter optionally comprises a non-carbon fibrous material.

21. The flat-planar assembly of claim 20, wherein said pre-filter comprises at least three of said carbon containing layers and said filter comprises at least two said carbon containing layers.

22. The flat-planar assembly of claim 20, wherein the combination of said pre-filter and said filter reduce the biological concentration of at least one of the following:
viruses by at least 10,000 times (4 LRV);
bacteria by at least one million times (6 LRV); and
cysts by one thousand times (3 LRV), at a flow of at least 1 cm/min at pressure differential across said filter not exceeding 50 psi.

23. The flat-planar assembly of claim 20, wherein at least 0.01% by weight of the carbon containing layer of the pre-filter, the filter, or both are surface grown carbon nanotubes.

24. The flat-planar assembly of claim 20, wherein the carbon containing layer of the pre-filter, the filter, or both further contain an activated carbon material.

25. A method of purifying biologically contaminated water, said method comprising:
passing biologically contaminated water through a pre-filter comprising at least one carbon containing layer to produce a pre-filtered water;
passing said pre-filtered water through a filter comprising at least one carbon containing layer to produce a potable water product, wherein the at least one carbon containing layer of the pre-filter, the filter, or both the pre-filter and the filter has a water permeability ranging from 0.05 Darcies to 20 Darcies.

26. The method of claim 25, wherein said biologically contaminated water comprises virus, bacteria, parasites, endotoxins, pesticides, organophosphates, hormone analogs, pharmaceuticals, and microorganisms.
